(19) United States
(12) Patent Application Publication
(10) Pub. No.: US 2003/0170356 A1
(43) Pub. Date: Sep. 11, 2003

(54) High pressure processing of a substance utilizing a controlled atmospheric environment

(76) Inventors: James T.C. Yuan, Naperville, IL (US); Henry Ledon, Versailles (FR)

Correspondence Address: Linda K. Russell, Suite 1800, 2700 Post Oak Blvd., Houston, TX, 77056, US

(21) Appl. No.: 10/342,342

(22) Filed: Jan. 15, 2003

Related U.S. Application Data
(60) Provisional application No. 60/358,113, filed on Feb. 19, 2002.

(51) Int. Cl. A23C 1/00

(52) U.S. Cl. 426/313

(57) ABSTRACT

A method of processing a substance, such as a food item, utilizing high pressure processing includes providing an enclosed environment including the substance and one or more of the following gases: carbon monoxide, carbon dioxide, nitrogen, nitric oxide, nitrous oxide, hydrogen, oxygen, helium, argon, krypton, xenon and neon. The enclosed environment including the substance and at least one gas is subjected to high pressure processing and sealed in a container. The high pressure processing may occur prior to or after sealing the substance in the container. Control of the amount and type of gases in the enclosed environment including the substance enhances the biocidal efficacy of high pressure processing as well as ensuring desirable sensory qualities of the substance during storage.

### CROSS REFERENCE TO RELATED APPLICATIONS

This application claims priority from U.S. Provisional Patent Application Serial No. 60/358,113, entitled “Method of Modified Atmosphere During High Pressure Processing” and filed Feb. 19, 2001. The disclosure of the above-mentioned provisional application is incorporated herein by reference in its entirety.

### BACKGROUND OF THE INVENTION

1. Technical Field

The present invention pertains to high pressure processing of packaged food items to improve safety and sensory qualities (e.g., smell, taste, texture) of the food items prior to and during consumption of such food items.

2. Discussion of the Related Art

A variety of techniques are presently known for preserving packaged foods to maintain food safety and desirable sensory characteristics prior to consumption. The most common forms of food preservation involve subjecting the food to one or more temperature conditions, such as heating, refrigeration and/or freezing.

Another method of food preservation utilizes high pressure processing (HPP), which involves the application of a high pressure to food items at a selected temperature and for a selected time interval, followed by rapid depressurization to surrounding atmospheric conditions. Food items processed utilizing HPP tend to have a better retention of flavor, texture, color and nutrients in comparison to conventional forms of heat processing. In addition, HPP effectively disrupts and destroys microbial organisms such as Salmonella and E. coli. High pressure processing further inactivates certain types of enzymes in foods that would otherwise result in food spoilage and/or undesirable sensory characteristics for the food.

While HPP treatment provides many useful benefits in preserving foods in comparison to conventional heat treatment techniques, there are some concerns with this form of food processing. For example, HPP is not effective in destroying certain types of bacterial cells or spores that are resistant to pressure. In addition, HPP may enhance certain undesirable enzymatic activities after treatment of the food.

Certain modifications to HPP techniques have been employed in the art in an attempt to control undesirable enzymatic activity after food treatment and enhance sensory characteristics of the food. For example, a method for processing foods is described in published International Application No. PCT/SE99/01045. The method describes subjecting food to an overpressure of carbon dioxide prior to high pressure stabilization treatment to reduce enzyme activity that may produce off flavors in the food. In particular, the method includes preparing the food, mixing the food into a suitable mixture of solids and liquids, subjecting the food to vacuum to remove air, mixing the food with carbon dioxide gas, and subjecting the food to high pressure. During the mixing of the food with the carbon dioxide, the carbon dioxide is maintained at an over pressure less than a pressure at which the food is seen to sparkle after high pressure treatment.

Another method for processing food to prevent food discoloration caused by oxidation in high pressure treatment is described in published Japanese Patent Application No. 01219619. In this method, a packaging vessel containing food is vacuum evacuated and charged with an inert gas such as nitrogen and sealed. The sealed package containing the food is then immersed in a liquid medium preferably at a temperature of 100° C. and subjected to high pressure for a prescribed time period.

While HPP treatments have been modified as noted above by adding carbon dioxide or nitrogen to the food processing in order to control enzymatic activity and to improve sensory characteristics (e.g., color) of the food, improvements in HPP processing for foods are still desirable to effect adequate destruction of microorganisms present in the food in combination with maintaining desirable food characteristics.

### OBJECTS AND SUMMARY OF THE INVENTION

Accordingly, it is an object of the present invention to provide a high pressure processing method for preserving packaged food items so as to render the food items available for consumption after a selected period of time.

It is another object of the present invention to maintain desirable sensory qualities of the food prior to consumption.

It is a further object of the present invention to ensure adequate destruction of microorganisms disposed within the food items during the high pressure processing and to retard the growth rate of surviving microorganisms subsequent to the high pressure processing so as to prevent spoilage of the food items prior to consumption.

The aforesaid objects are achieved individually and/or in combination, and it is not intended that the present invention be construed as requiring two or more of the objects to be combined unless expressly required by the claims attached hereto.

According to the present invention, a method of high pressure processing (HPP) of a substance is provided in which an enclosed environment surrounding the substance includes at least one gas selected from the group consisting of carbon monoxide (CO), nitric oxide (NO), nitrous oxide (N₂O), hydrogen (H₂), oxygen (O₂), and a noble gas such as helium (He), argon (Ar), krypton (Kr), xenon (Xe) and neon (Ne). In addition, the enclosed environment may further include at least one of carbon dioxide (CO₂) and nitrogen (N₂). Alternatively, the enclosed environment may include at least two gases selected from the group consisting of carbon monoxide (CO), nitric oxide (NO), nitrous oxide (N₂O), hydrogen (H₂), oxygen (O₂), and a noble gas such as helium (He), argon (Ar), krypton (Kr), xenon (Xe) and neon (Ne), carbon dioxide (CO₂) and nitrogen (N₂). In an exemplary method, food items are flushed with one or more of the previously noted gases in a storage container. The container is then sealed to form a controlled atmospheric environment therein that includes the one or more process gases and the food items. The container is further subjected to HPP treatment applied externally to the package for a selected period of time and at a selected temperature. Alternatively, an enclosed environment including the substance and one or more gases may be subjected to HPP treatment prior to transfer of the substance to a storage container. Selection of one or more gases to be included in the enclosed environment will depend upon factors such as the types of food items to be preserved, types of microorganisms targeted for destruction, and/or particular sensory characteristics of the food items to be preserved. The one or more gases included in the enclosed environment enhance the biocidal efficacy of the HPP treatment as well as provide an optimal atmospheric environment against chemical degradation or any other quality deterioration (e.g., color, flavor, aroma, appearance, texture, chemical stability, etc.) of the substance. The temperature of the substance may further be maintained at a selected temperature range prior to, during and/or after the HPP treatment.

The above and still further objects, features and advantages of the present invention will become apparent upon consideration of the following detailed description of specific embodiments thereof.

### BRIEF DESCRIPTION OF THE DRAWINGS

FIG. 1 is a chart depicting the number of E. coli destroyed in sample pouches that contained controlled atmospheric environments including selected process gas mixtures, where the sample pouches were subjected to HPP treatments in accordance with the present invention.

FIG. 2 is another chart depicting the number of Bacillus subtilis spores destroyed in sample pouches that contained controlled atmospheric environments including selected process gas mixtures, where the sample pouches were subjected to HPP treatments in accordance with the present invention.

### DETAILED DESCRIPTION OF THE PREFERRED EMBODIMENTS

A method of treating a food substance utilizing high pressure processing (HPP) according to the present invention includes flushing the substance with one or more selected process gases prior to HPP treatment and sealing the substance in a storage container so as to retain the substance in a controlled atmospheric environment that includes the selected process gases. Preferably, the substance to be treated includes one or more food items to be preserved within the storage container. The food items to be processed may be in any state (e.g., solid, liquid, one or more solids in liquid suspension, etc.), and the storage container may be of any suitable type having sufficient structural integrity to retain selected food items. Exemplary types of food items that may be preserved include, without limitation, beverages (e.g., juices, milk, etc.), prepared foods, fresh produce (e.g., fruits, vegetables, etc.) and meats (e.g., poultry, beef, seafood, etc.). The food items may be treated prior to HPP treatment utilizing any one or more suitable methods (e.g., filtration for liquid food items, thermal treatment, UV treatment, etc.). Alternatively, the treatment may be conducted in combination with the HPP treatment. In particular, food items that are very heat sensitive may be sanitized in an efficient manner utilizing minimal thermal processing before and/or during HPP treatment.

Preferably, the container is configured for sealing after injection of the food items and processed gases therein and is gas impermeable or has a selected gas permeability to ensure the atmospheric environment surrounding the food items within the container is controlled until the container is re-opened. An exemplary type of storage container may be of a tray type that includes a top lid film to seal the tray upon injection of the food items and process gas.

The term “HPP”, as used herein, refers to application of an external pressure to the controlled atmospheric environment including the substance and process gas mixture. Preferably, HPP treatment includes the application of the external pressure to the controlled atmospheric environment for a selected time period so as to effect compression of the substance within the environment, followed by rapid depressurization of the controlled atmospheric environment. The HPP treatment may further include the application of a series of two or more pulsed external pressures to the controlled atmospheric environment, where the application time and amount of each pulsed external pressure may be the same or different.

The external pressure applied during HPP treatment is above at least about 1 atm. Exemplary pressures suitable for achieving a selected biocidal efficacy and desirable sensory qualities for food items processed utilizing HPP treatment are in the range of about 50 megaPascals (MPa) to about 10,000 MPa. Pressurization of the food items in the controlled atmospheric environment may be accomplished when the food items are disposed within the storage container. In such methods, the container is preferably of a suitable flexibility and has sufficient structural integrity to withstand the amount of external pressure applied to the container during HPP treatment while transmitting such pressure to the controlled atmospheric environment and food items disposed within the container. Alternatively, the food items in the controlled atmospheric environment may be subjected to HPP treatment in a pressurization chamber and subsequently placed within the storage container as described below.

Any one or combination of gases may be utilized to form the process gas mixture that is included in the controlled atmospheric environment. In particular, the process gas mixture may include one or more of the following gases: carbon monoxide (CO), nitric oxide (NO), nitrous oxide (N₂O), hydrogen (H₂), oxygen (O₂), and one or more of the noble gases including helium (He), argon (Ar), krypton (Kr), xenon (Xe) and neon (Ne). In addition, any one or both of carbon dioxide (CO₂) and nitrogen (N₂) may further be included in the process gas mixture along with any one or more of the previously noted gases. Alternatively, the process gas mixture may include any two or more of the following gases: CO, CO₂, N₂, NO, N₂O, H₂, O₂, He, Ar, Kr, Xe and Ne. The concentration of any of the previously noted gases in the process gas mixture is preferably in the range of about 0.2-100% by total volume of the process gas mixture. In addition, when utilizing CO₂, the preferred concentration of CO₂ in the process gas mixture is in the range of about 20-80% by total volume of the process gas mixture. The process gas mixture is preferably provided in the controlled atmospheric environment including the food items in an amount greater than about 1 part per million (ppm). The process gas mixture may further be applied to the food items at any suitable pressure within the atmospheric environment in which the food items are disposed. It is noted that a selected solubility of the process gas mixture in the food items may be achieved prior to HPP treatment by controlling the pressure of the controlled atmospheric environment in which the food items are disposed during flushing of the food items with the process gas or gases. A greater solubility of a particular gas (e.g., O₂) in a food item may enhance the biocidal efficacy for a targeted microorganism during HPP treatment.

The amount of compressive heat transfer to the food items as a result of the HPP treatment may be controlled in a number of ways. For example, in situations where it is desirable to maintain food items at substantially the same temperature during HPP treatment, the food items may be cooled (e.g., refrigerated) for a selected time period prior to HPP treatment. Alternatively, or in combination with the pre-HPP cooling treatment of the food items, a pressurizing medium may be utilized in the HPP treatment that limits heat transfer to the food items by absorbing much of the heat generated during compression. In other situations where it is desirable to heat the food items to an elevated temperature during HPP treatment, heating of the food items is provided in combination with HPP treatment. The temperature of the food items during HPP treatment is preferably maintained within a range of about −300° C. to about 150° C. It is noted that the selection of a precise temperature range to be maintained during a particular processing method will depend upon a number of factors including, without limitation, the food item or items being processed in the controlled atmospheric environment, the type and amount of each process gas in such environment, and the amount of external pressure being applied to the food items during HPP treatment.

Any suitable method for applying a pressure to the controlled atmospheric environment including the process gas mixture and food items may be utilized in accordance with the present invention. In an exemplary embodiment, food items are subjected to HPP treatment after being sealed within a flexible pouch container in a controlled atmospheric environment with a process gas mixture. The pouch container includes an opening for receiving the food items and process gas or gases. Prior to injection of the food items, the pouch container may optionally be evacuated utilizing a suitable vacuum device. In an additional optional step, the pouch container may also be flushed with the process gas mixture prior to insertion of the food items therein. Selected food items are inserted within the pouch container, and the food items are flushed with the process gas mixture including any number (e.g., one) of the previously described process gases with or without CO₂ and/or N₂. The process gas mixture is flushed into the pouch container including the food items for a selected period of time and at a selected pressure. Flushing of the gas mixture within the pouch container may be accomplished, e.g., by inserting one or more selected gas supply conduits within the opening of the pouch container to facilitate delivery of the gas mixture into the pouch. The opening of the pouch container is sealed (e.g., via application of heat) upon completion of the flushing step. Thus, the sealed pouch container includes the food items disposed in a controlled atmospheric environment including the process gas mixture. As previously noted, the pouch container preferably has a selected gas permeability to prevent or limit gases from entering or leaving the pouch container so as to maintain the desired atmospheric environment therein.

High pressure processing treatment is preferably applied to the sealed pouch container by submersing the container in a pressurization chamber containing a pressure transmitting fluid. An exemplary pressurization chamber suitable for providing effective HPP treatment is a Quintus Food Processor Model 6 (Flow International Company, Columbus, Ohio). However, it is noted that the external pressure may be applied to the pouch container utilizing any other suitable pressurizing device. Preferably, the pressure transmitting fluid in the chamber includes a glycol to control the transfer of heat to the food items as a result of compression heating during HPP treatment. For example, the transmitting fluid may be a 50:50 mixture of water and glycol. As previously noted, the temperature of the food items may further be controlled during HPP treatment by subjecting the food items to a selected thermal treatment (e.g., cooling) prior to the HPP treatment. In the present example, the sealed pouch containing the food items are refrigerated for a sufficient time to achieve a selected temperature and to ensure that, during HPP treatment, the food items do not exceed a threshold temperature. In addition, the pouch may be cooled immediately after HPP treatment (e.g., by submersing in an ice water bath) to prevent an undesirable escalation in temperature of the food items. The pressurization chamber and transmitting fluid may further be temperature controlled (e.g., via heating elements disposed at suitable locations within the pressurization chamber) to facilitate direct thermal treatment (i.e., heating or cooling) in combination with compression heating of the food items during HPP treatment.

Upon placing the sealed pouch container within the pressurization chamber containing the transmitting fluid, the chamber is closed and a pressure is applied within the chamber to the transmitting fluid. The transmitting fluid transmits the applied pressure externally to the pouch container and, thus, to the controlled atmospheric environment within the pouch container and surrounding the food items. In particular, a specific pressure is input by the operator of the pressurization chamber, along with a time for maintaining the specific pressure and, optionally, a temperature to be maintained within the chamber. Upon completion of the HPP treatment, the pouch container is removed from the pressurization chamber and is ready for storage.

The combination of the HPP treatment with the controlled atmospheric environment in the package results in an acceleration of the destruction and inactivation of microorganisms within the environment as well as providing an inerting effect within the environment that preserves the food items and maintains desirable sensory qualities for the food prior to consumption. The controlled atmospheric environment further retards the growth rate of any microorganisms that may have survived the HPP treatment, thus increasing the storage time or “shelf life” in which the food items are available for consumption without risk of spoilage.

In another exemplary embodiment, the food items are subjected to HPP treatment in a controlled atmospheric environment prior to packaging in a suitable container. In particular, the food items are placed within a sealed vessel, which may optionally be vacuum treated and/or flushed with the process gas mixture first, followed by flushing of the process gas mixture at a selected pressure and for a selected time period within the vessel. Flushing of the gas mixture may be accomplished by providing one or more gas supply conduits to the vessel along with suitable valves to adjust the internal pressure within the vessel in accordance with desired processing conditions. Thus, internal pressurization of the controlled atmospheric environment may be set to a desired level in order to facilitate a selected solubility of one or more process gases within the food items. Upon flushing the food items with the process gas mixture, the contents of the sealed vessel are transferred, via a suitable conduit and while maintaining the internal pressure of the controlled atmospheric environment, to a pressurization vessel. The internal volume of the pressurization vessel is selectively adjusted (e.g., via a piston disposed within the pressurization vessel) to apply the selected amount of external pressure to the food items disposed within the controlled atmospheric environment during HPP treatment. Alternatively, a single sealed vessel may be utilized to flush the food items with the process gas mixture and to apply the HPP treatment, thus obviating the need for transferring the food items and gases between two vessels during processing. The temperature of the food items may be controlled during HPP treatment in a similar manner as described above (e.g., by cooling the food items prior to HPP treatment, controlling the temperature within the pressurization vessel via heating elements, etc.). After applying HPP treatment at a selected pressure and for a selected time period, the controlled atmospheric environment including the food items is transferred to a suitable packaging container, and the packaging container is sealed and ready for storage.

The selection and amount of a particular one or more of the previously described gases to be included in the process gas mixture is a function of a number of factors including, without limitation, the type of food items being preserved, the desired storage time or “shelf life” of the food items, HPP treatment conditions (e.g., amount of pressure applied), the type or types of microorganisms being targeted, and the type or types of food enzymes to be inactivated so as to control food color, taste, texture and other sensory characteristics of the food items. For example, in situations where a certain microorganism is prevalent for a particular food item, one process gas mixture may be more effective than another in achieving a desired level of destruction and inactivation of the microorganism after HPP treatment. The following two examples show the efficacy of different process gas mixtures applied during HPP treatments in accordance with the present invention for two different bacterial strains.

### EXAMPLE 1

Three strains of Escherichia coli (obtained from Center for Food Safety, University of Georgia, Griffin, Ga.) were maintained in tryptic soy broth (Difco Laboratories, Detroit, Mich.) at 4° C. Cultures containing equal amounts of the three strains were activated at 35° C. for 24 hours in the tryptic soy broth (TSB). Inoculum was prepared by diluting the overnight cultures in Sorensen's phosphate buffer at a pH of 7.0 and at 2° C. Numbers of inoculum were determined by plating serially diluted samples on E. coli/Coliform Petrifilm™ (3M Company, St. Paul, Minn.), where the E. coli/Coliform was incubated aerobically at 35° C. for 48 hours.

Pouches of inoculum samples were prepared in the following manner. A sample of inoculum solution was placed in a stainless steel vessel disposed in ice slurry and flushed with a process gas mixture containing one of the following gases: argon, oxygen, carbon dioxide, nitrogen and helium. In addition, control samples were prepared in which the inoculum samples were not flushed with any gas. Upon being flushed with the selected gas mixture, each inoculum sample was withdrawn into a pouch made from a gas impermeable film. The pouch was immediately sealed with a heat sealer and placed inside of an outer pouch filled with 10 milliliters (ml) of water. The outer pouch was in turn heat sealed. The pouches containing inoculum samples flushed with different process gas mixtures were stored at 2° C. overnight prior to HPP treatment.

Sample pouches were processed with a Quintus Food Processor Model 6 (Flow International Company, Columbus, Ohio) under various applied temperature, pressure and time combinations. The pressurization chamber of the processor was filled with a pressure transmitting fluid consisting of a 50:50 mixture of water and glycol. A pressure of 70 Kpsi (˜483 MPa) was applied to samples for periods of 2 minutes and 5 minutes, where the temperature within the pressurization chamber was maintained at about 10° C. Once a pressure of 70 Kpsi was achieved inside the pressurization chamber for each sample, that pressure was maintained for the set process time of either 2 or 5 minutes. Upon expiration of the set process time, the pressure was released within the chamber. Samples were immediately cooled after HPP treatment by placement in ice slurry.

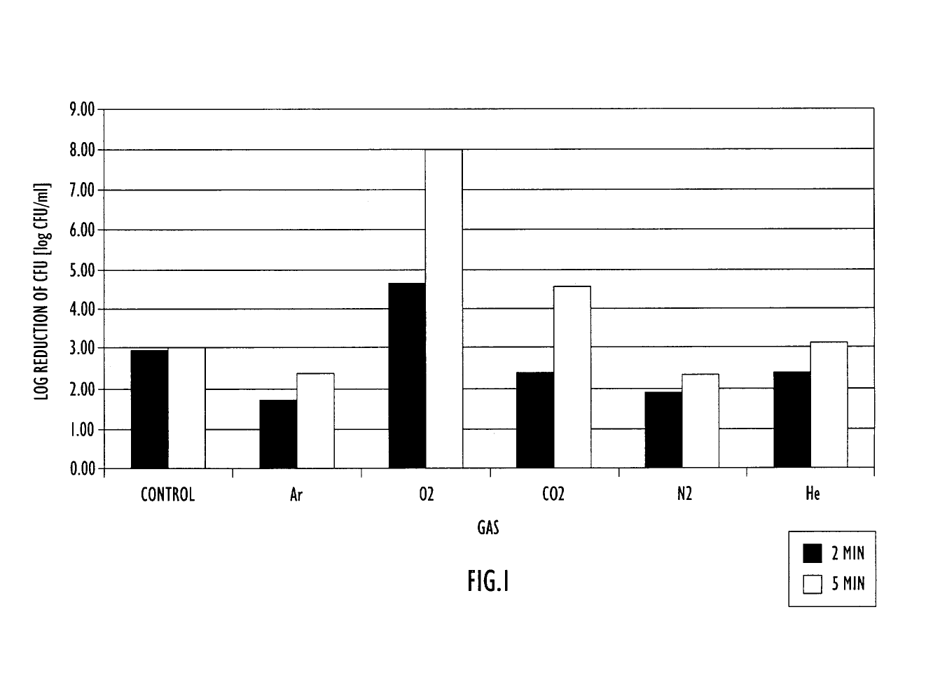

The results of biocidal efficacy on the samples based upon the particular process gas utilized and HPP processing time are depicted in the chart of FIG. 1. The vertical axis of the chart displays a log reduction of Colony Forming Units (CFU) in log CFU/milliliter (ml), thus representing an amount of E. Coli killed as a result of the combined HPP and controlled atmosphere processing treatment. The results plotted in FIG. 1 indicate that, of the process gas mixtures sampled, oxygen provides the greatest biocidal efficacy at both the 2 minute and 5 minute processing times. Further, carbon dioxide provides the second best biocidal efficacy at the 5 minute processing time. In contrast, argon and nitrogen provided poor results, providing a lower reduction in bacterial cells at both processing times in comparison with the control sample. Thus, in situations where E. coli is of particular concern for food items, the results indicate that oxygen, or perhaps a combination of oxygen with carbon dioxide, would serve as an effective process gas mixture for the controlled atmospheric environment of the food items during food packaging methods employed by the present invention.

### EXAMPLE 2

Samples of a strain of Bacillus subtilis spores (obtained from Syracuse University, Syracuse, N.Y.) were prepared and packaged in pouches in a substantially similar manner as in the previous example, with the numbers of inoculum in the samples also being determined in a similar manner as described in the previous example and utilizing appropriate count plates. The process gas mixtures utilized for the samples were as follows: oxygen, carbon dioxide, nitrous oxide, argon, hydrogen and air. In addition, control samples were prepared which were not flushed with any process gas mixture.

The HPP treatments for the samples were performed utilizing the same processor as in the previous example. However, a double pressure pulse method was applied to each sample. The double pressure pulse included a first pressure applied for a select time period, followed by depressurization, and then re-pressurization to a second pressure for a select time period. In particular, the following pulse pressurizations methods were applied for the samples:

Process A: 1. Pressurize chamber to 30 Kpsi (˜207 MPa) at 40° C. for 1 minute 2. Depressurize chamber 3. Pressurize chamber to 50 Kpsi (˜345 MPa) at 40° C. for 1 minute

Process B: 1. Pressurize chamber to 10 Kpsi (˜69 MPa) at 20° C. for 1 minute 2. Depressurize chamber 3. Pressurize chamber to 50 Kpsi (˜345 MPa) at 20° C. for 1 minute

Process C: 1. Pressurize chamber to 10 Kpsi (˜69 MPa) at 40° C. for 1 minute 2. Depressurize chamber 3. Pressurize chamber to 50 Kpsi (˜345 MPa) at 40° C. for 1 minute

Process D: 1. Pressurize chamber to 30 Kpsi (˜207 MPa) at 40° C. for 30 minutes 2. Depressurize chamber 3. Pressurize chamber to 70 Kpsi (˜483 MPa) at 40° C. for 2 minutes

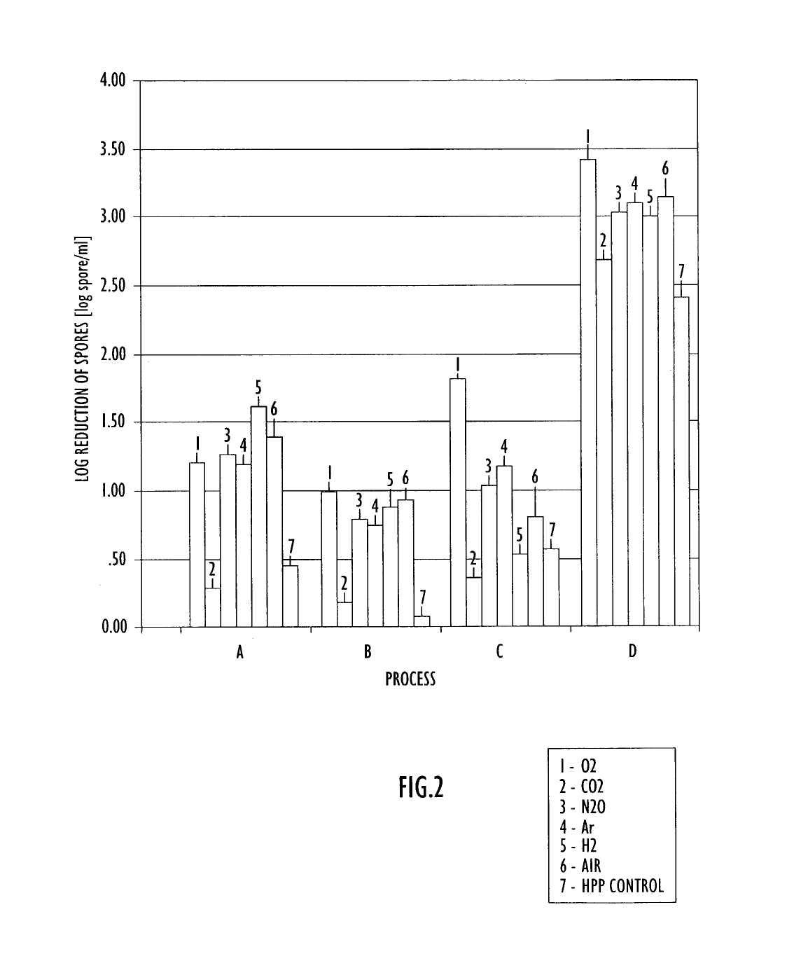

The results of biocidal efficacy on the samples based upon the particular process gas utilized and HPP processing method (i.e., processes A-D) is depicted in the chart of FIG. 2. The numbers 1-7 depicted in the chart and associated with each processing method correspond to the following process gas mixtures utilized for a particular sample: 1-oxygen, 2-carbon dioxide, 3-nitrous oxide, 4-argon, 5-hydrogen, 6-air, and 7-control.

The chart depicted in FIG. 2 is similar to the chart of FIG. 1, with the vertical axis providing an indication as to the biocidal efficacy of the particular HPP/process gas mixture method. The results indicate that, based upon the HPP/process gas mixture method employed, hydrogen or oxygen gas provides the greatest reduction in Bacillus subtilis spores. In contrast to the previous example, carbon dioxide is not very effective in achieving spore reduction in any of processes A-D, whereas argon and nitrous oxide provide effective spore reduction in each of the processes. In addition, the use of air, which is a combination of primarily oxygen and nitrogen, provided an effective process gas mixture that yielded good results in reduction of spores.

While the methods described above are associated with the preservation of food items, it is noted that any suitable substance may be processed in accordance with the present invention to enhance the storage time or “shelf life” while preventing or minimizing degradation of the substance with regard to its intended use.

Having described novel methods of high pressure processing of a substance utilizing a controlled atmospheric environment, it is believed that other modifications, variations and changes will be suggested to those skilled in the art in view of the teachings set forth herein. It is therefore to be understood that all such variations, modifications and changes are believed to fall within the scope of the present invention as defined by the appended claims.

What is claimed is:

1. A method of processing a substance comprising:
providing an enclosed environment including the substance and at least one gas selected from the group consisting of carbon monoxide, nitric oxide, nitrous oxide, hydrogen, oxygen, helium, argon, krypton, xenon and neon; and
applying a pressure to the substance within the enclosed environment including the at least one gas so as to effect a compression of the substance.

2. The method of claim 1, wherein the enclosed environment further includes at least one additional gas selected from the group consisting of carbon dioxide and nitrogen.

3. A method of treating a substance for packaging comprising:
providing an enclosed environment including the substance and at least one gas selected from the group consisting of carbon monoxide, nitric oxide, nitrous oxide, hydrogen, oxygen, helium, argon, krypton, xenon and neon;
applying an external pressure to the enclosed environment including the substance and the at least one gas; and
sealing the substance in a storage container.

4. The method of claim 3, wherein the enclosed environment further includes at least one additional gas selected from the group consisting of carbon dioxide and nitrogen.

5. The method of claim 3, wherein the enclosed environment is formed upon sealing of the substance in the storage container, and the external pressure is applied to the storage container.

6. The method of claim 3, wherein the external pressure is applied in an amount of at least about 50 MPa.

7. The method of claim 3, wherein the substance comprises at least one food item.

8. The method of claim 3, wherein the enclosed environment comprising the substance and at least one gas is provided by:
inserting the substance within the enclosed environment; and
flushing the at least one gas within the enclosed environment.

9. The method of claim 8, further comprising:
flushing the at least one gas within the enclosed environment at a predetermined pressure so as to achieve a selected solubility of the at least one gas within the substance.

10. The method of claim 8, further comprising:
vacuuming the enclosed environment prior to insertion of the substance therein.

11. The method of claim 3, further comprising:
controlling the temperature of the substance within a selected temperature range during the application of the external pressure to the enclosed environment.

12. The method of claim 3, further comprising:
cooling the substance within the enclosed environment within a selected temperature range prior to the application of the external pressure to the enclosed environment.

13. The method of claim 3, further comprising:
providing the at least one gas for inclusion in the enclosed environment so as to selectively control chemical deterioration as well as an amount of destruction and inactivation of at least one type of microorganism disposed in the enclosed environment upon completion of the application of the external pressure to the enclosed environment.

14. A packaged product manufactured according to the method of claim 3.

15. A method of treating a substance for packaging comprising:
providing an enclosed environment including the substance and a gas mixture including at least two gases selected from the group consisting of carbon monoxide, nitric oxide, nitrous oxide, hydrogen, oxygen, helium, argon, krypton, xenon, neon, carbon dioxide and nitrogen;
applying an external pressure to the enclosed environment including the substance and the gas mixture; and
sealing the substance in a storage container.
